(19) United States
(12) Patent Application Publication
(10) Pub. No.: US 2024/0347886 A1
(43) Pub. Date: Oct. 17, 2024

(54) BEAMFORMER

(71) Applicant: Nippon Telegraph and Telephone Corporation, Tokyo (JP)

(72) Inventors: Adam Pander, Tokyo (JP); Hiroshi Hamada, Tokyo (JP)

(21) Appl. No.: 18/577,783

(22) PCT Filed: Jul. 12, 2021
(86) PCT No.: PCT/JP2021/026170

§ 371 Date: Jan. 9, 2024

(51) Int. Cl. H01P 1/18; H01P 3/12; H01Q 21/00

(52) U.S. Cl. CPC H01P 1/182; H01P 3/121; H01Q 21/0031

(57) ABSTRACT

A beamformer includes a waveguide through which an electromagnetic wave is transmitted, a phase shifter placed in the waveguide, and a bias chip electrically connected to the phase shifter, the phase shifter includes a metamaterial cell having a capacitive element on a dielectric substrate, and the bias chip applies a voltage to the metamaterial cell, thereby changing a capacitance of the capacitive element and a phase of the electromagnetic wave.

### CROSS-REFERENCE TO RELATED APPLICATIONS

This patent application is a national phase entry of PCT Application No. PCT/JP2021/026170, filed on Jul. 12, 2021, which application is hereby incorporated herein by reference.

### TECHNICAL FIELD

The present invention relates to a waveguide beamformer using a metamaterial.

### BACKGROUND

In high-frequency wireless communication, millimeter-wave antennas having high directivity are necessary, and beamforming is attracting attention. In beamforming, high-directivity electromagnetic radiation beams are formed by combining individual signals emitted from an array at various frequencies, and these high-directivity beams are steered, in order to maintain the signal quality.

In beamforming, a radiation beam in a specific direction is obtained by accurately matching the phases of signals input from different portions of the array. The phases are adjusted by using an arrangement (phase array) obtained by arraying elements (e.g., antennas) for steering radiation beams, and connecting phase shifters.

Digital beamforming converts signals sampled from the antenna elements into a low frequency by mixing the outputs from an analog-to-digital converter, thereby generating a baseband signal. The baseband signal is divided between different channels, and transmitted to a beamformer. The beamformer corrects and steers the signals, and forms radiation beams. This digital beamforming technique can form uniform beams without any phase transition in an operation bandwidth region.

### CITATION LIST

### Non Patent Literature

### NPL 1

Iyemeh Uchendu et al., “Survey of Beam Steering Techniques Available for Millimeter Wave Applications”, Progress In Electromagnetics Research B, Vol. 68 (2016) p. 35-54.

### NPL 2

Zargham Baghchehsaraei et al., “Waveguide-integrated MEMS-based phase shifter for phased array antenna”, IET Microwaves Antennas and Propagation, Institution of Engineering and Technology, 2014, 8 (4), pp. 235-243.

### SUMMARY

### Technical Problem

However, the above-described conventional beamforming techniques require high costs and high power consumption. In addition, the conventional techniques are effective in a low-frequency band, but pose the following problems because the operation frequency increases to the millimeter-wave band.

First, beamforming in the millimeter-wave frequency band produces a high loss in phase shift. An incidence loss occurs when a device is inserted into a transmission path, and this incidence loss wastes power and degrades the system performance. Also, a loss in a semiconductor device increases as the operation frequency increases, and this hinders an application of the phase shifter.

Second, the size of a circuit element (element) must be decreased in order to increase the operation frequency of the device. For example, in a typical phase antenna array, the directivity and gain of a signal antenna element in a high-frequency region are smaller than those in a low-frequency region, and are limited by the physical dimensions and operation frequency of the antenna as indicated by equation (1):

$$\begin{matrix}Equation 1 & \\ {D}_{max} = \frac{4 π A}{{λ}_{0}^{2}} & ( 1 )\end{matrix}$$

Third, since beamforming in a high-frequency region is sensitive to a phase variation, highly accurate circuit design and fabrication are necessary, so the structure of the phase shifter becomes more expensive and more complicated. As described above, the phase array antenna requires a complicated beamforming network in a high-frequency region. The problem is that this complicated beamforming network increases the losses of the system and signals and decreases the signal intensity by phase variation.

Fourth, a phase shifter in a phase array that is electrically steered depends on the frequency, and hence causes various phase shifts depending on the bandwidth. A problem arises because this restricts the operation in the millimeter-wave band requiring a large bandwidth.

As described above, when forming a highly directive beam by applying the conventional beamforming techniques to the millimeter-wave band, the loss and the element size are the problems caused by the phase shifter, and the complexity and the cost are the problems related to the frequency dependence.

### Solution to Problem

To solve the problems as described above, a beamformer according to embodiments of the present invention includes a waveguide through which an electromagnetic wave is transmitted, a phase shifter placed in the waveguide, and a bias chip electrically connected to the phase shifter, wherein the phase shifter includes a metamaterial cell having a capacitive element, and the bias chip applies a voltage to the metamaterial cell, thereby changing a capacitance of the capacitive element and a phase of the electromagnetic wave.

### Advantageous Effects

Embodiments of the present invention can provide a beamformer having a good transmission characteristic, capable of steering a beam at a wide angle, and having a simple structure.

### BRIEF DESCRIPTION OF THE DRAWINGS

FIG. 1A is a schematic view of a beamformer according to the first embodiment of the present invention;

FIG. 1B is a schematic sectional view showing the arrangement of a phase shifter and its periphery in the beamformer according to the first embodiment of the present invention;

FIG. 2A is a schematic view showing configuration examples of a metamaterial cell in the beamformer according to the first embodiment of the present invention;

FIG. 2B is a schematic view showing geometric parameters of the metamaterial cell in the beamformer according to the first embodiment of the present invention;

FIG. 3 is a view for explaining the operation of the metamaterial cell in the beamformer according to the first embodiment of the present invention;

FIG. 4 is a view for explaining the operation of the metamaterial cell in the beamformer according to the first embodiment of the present invention;

FIG. 5 is a view for explaining the operation of the metamaterial cell in the beamformer according to the first embodiment of the present invention;

FIG. 6A is a schematic perspective view showing the arrangement of a waveguide in the beamformer according to the first embodiment of the present invention;

FIG. 6B is a schematic front cross-sectional view showing the arrangement of the waveguide in the beamformer according to the first embodiment of the present invention;

FIG. 6C is a schematic side cross-sectional view showing the arrangement of the waveguide in the beamformer according to the first embodiment of the present invention;

FIG. 7A is a view for explaining the operation of the waveguide in the beamformer according to the first embodiment of the present invention;

FIG. 7B is a view for explaining the operation of the waveguide in the beamformer according to the first embodiment of the present invention;

FIG. 8A is a view for explaining the operation of the waveguide in the beamformer according to the first embodiment of the present invention;

FIG. 8B is a view for explaining the operation of the waveguide in the beamformer according to the first embodiment of the present invention;

FIG. 8C is a view for explaining the operation of the waveguide in the beamformer according to the first embodiment of the present invention;

FIG. 9A is a schematic view showing the arrangement of the beamformer according to the first embodiment of the present invention;

FIG. 9B is a schematic view showing the arrangement of the beamformer according to the first embodiment of the present invention;

FIG. 10 is a view for explaining the operation of the beamformer according to the first embodiment of the present invention;

FIG. 11A is a schematic perspective view showing the arrangement of a waveguide in a beamformer according to the second embodiment of the present invention;

FIG. 11B is a schematic front cross-sectional view showing the arrangement of the waveguide in the beamformer according to the second embodiment of the present invention;

FIG. 12A is a view for explaining the operation of the waveguide in the beamformer according to the second embodiment of the present invention;

FIG. 12B is a view for explaining the operation of the waveguide in the beamformer according to the second embodiment of the present invention;

FIG. 12C is a view for explaining the operation of the waveguide in the beamformer according to the second embodiment of the present invention;

FIG. 13A is a view for explaining the operation of the waveguide in the beamformer according to the third embodiment of the present invention; and

FIG. 13B is a view for explaining the operation of the waveguide in the beamformer according to the third embodiment of the present invention.

### DETAILED DESCRIPTION OF ILLUSTRATIVE EMBODIMENTS

### First Embodiment

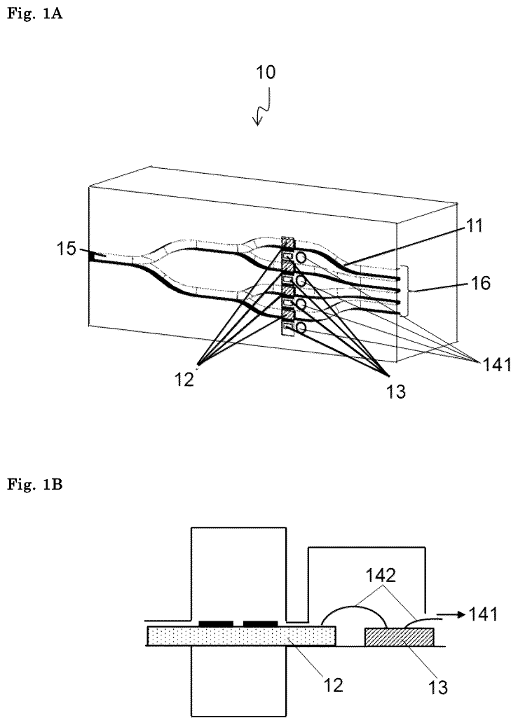

A beamformer according to the first embodiment of the present invention will be explained below with reference to FIGS. 1A to 10.

### Configuration of Beamformer

A beamformer 10 according to this embodiment includes a waveguide 11, phase shifters (phase shifter chips) 12, and bias chips 13 for controlling lumped capacitive elements.

The waveguide 11 is a rectangular hollow waveguide having a rectangular section, and made of a metal. As this metal, it is possible to use, e.g., brass, copper, silver, or aluminum, and a metal having a low bulk resistivity is desirable.

The phase shifter 12 includes a metamaterial cell 121 placed on a dielectric substrate, is connected to a single chip, and is placed inside the waveguide 11. The phase shifter 12 will also be referred to as a “metamaterial phase shifter” hereinafter.

The metamaterial cell 121 is a sub-wavelength metamaterial cell, and so designed as to resonate at a millimeter-wave frequency. As the metamaterial structure, it is possible to use a metal such as gold, copper, aluminum, or platinum, a material having a high electrical conductivity such as graphene, carbon nanotubes, or an electrically conductive oxide such as ITO or IGZO.

The dielectric substrate is made of a dielectric material, and it is possible to use, e.g., a silicone-based dielectric (silicon oxide or silicon nitride), GaAs, InP, a polymer, or BCB (benzocyclobutene).

The phase shifter 12 also has a lumped capacitive element. The lumped capacitive element is a device, such as a varactor diode or a transistor, which can control the capacitance by the applied voltage.

The bias chip 13 is placed outside the waveguide 11, and connected to the metamaterial phase shifter chip 12 as shown in FIG. 1B.

The metamaterial phase chip 12 is placed in the center of the waveguide 11 so that the surface faces up.

The metamaterial phase shifter chip 12 and the bias chip 13 are connected by wire bonding. The bias chip 13 and a bias pin 14 are connected in the same manner. By this connection, a bias voltage is applied from an external power source to the metamaterial phase shifter chip 12 via the bias pin 14 and the bias chip 13. A similar connection is formed to ground of the device.

In the beamformer 10, the rectangular hollow waveguide 11 is branched twice and consequently branched into four waveguides.

One input electromagnetic wave from an amplifier has a given frequency and a given phase, and is divided into four output waves by the waveguide 11. Here, these output waves have the same frequency as that of the input wave.

First, an electromagnetic wave (millimeter wave) is divided into four parallel waves having the same phase and the same intensity before reaching the metamaterial phase shifter chips 12.

Then, when the lumped capacitive element mounted in the gap of the metamaterial cell 121 of the phase shifter 12 is OFF or when all the lumped capacitive elements are biased by the same voltage, the electromagnetic waves are transmitted through the input parallel waveguides 11 while the phase of the electromagnetic waves remains unchanged.

On the other hand, when the lumped capacitive elements are ON and different biases are applied to the phase shifters 12, the electromagnetic waves are transmitted through the phase shifter chips 12, and the phase is changed by each channel of the waveguide 11 in accordance with the value of the lumped capacitance of the gap of the metamaterial.

In this embodiment, the metamaterial is used in the phase shifter. The metamaterial is an artificial medium, has characteristics obtained from an embedded sub-wavelength structure in which the metamaterial is arranged in the same manner as atoms in an ordinary material, shows desired values of the permittivity and the permeability within a measured frequency range, and steers an electromagnetic (EM) wave. The electromagnetic properties of the metamaterial result from the dimensions, shapes, directions, and layout of the periodic structures of a circuit and the materials made from these structures.

When using the metamaterial in a phase shifter or a beamformer, the transmission characteristic and the phase can be changed by the configuration and the layered structure of the metamaterial.

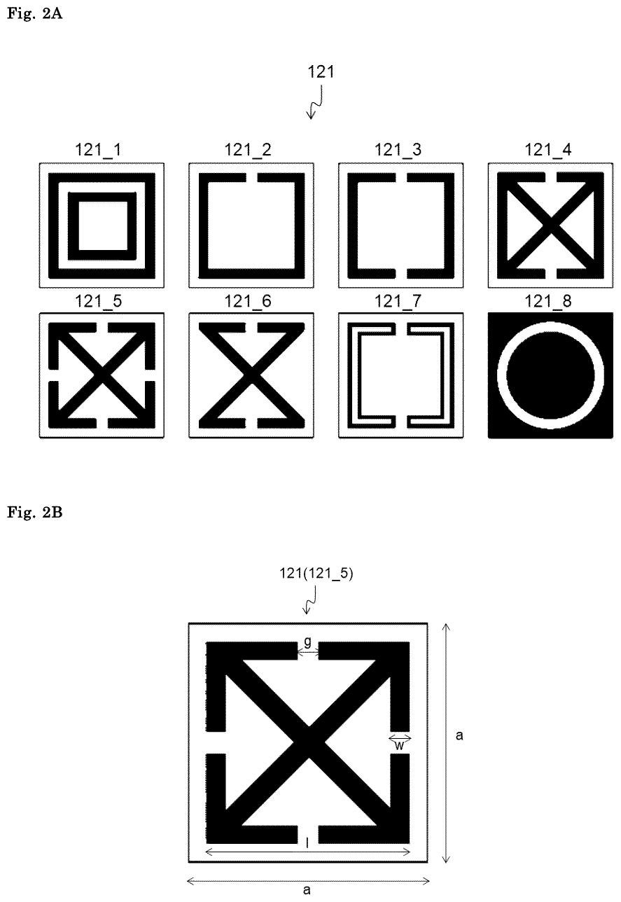

FIG. 2A shows shape examples 121_1 to 121_8 of the metamaterial cell 121. In this embodiment, the metamaterial phase shifter 12 includes a monolayered resonant metamaterial cell 121 formed on the dielectric substrate and having various shapes.

For example, the metamaterial cell 121 has a metal structure (e.g., a belt-like metal body) circling on the surface, and this metal structure has a discontinuous portion (gap).

The gap of the metal structure having a belt-like shape or the like and the end face of the opposing metal in the gap generate a capacitance.

As described above, the metamaterial phase shifter cell 121 has at least one gap in the metamaterial cell body. This gap is necessary to introduce the lumped capacitive element to the cell that controls the total capacitance value.

Since the resonant cell is used in the millimeter-wave band, its shape, dimensions, and period are adjusted (tuned) so as to achieve a desired frequency region. FIG. 2B shows geometric parameters of the metamaterial cell 121 by taking the shape 121_5 as an example.

In the metamaterial cell 121 (121_5), let l be the size (the length of one side of a square) of the cell, g be the length of the gap, w be the width of the belt-like metal structure, and a be the cell period.

The size of the metamaterial cell 121 is desirably smaller than the wavelength of an electromagnetic wave, and desirably ½ of the wavelength of an electromagnetic wave.

The resonance frequency of the metamaterial cell is represented by equation (2):

$$\begin{matrix}Equation 2 & \\ {f}_{R} = \frac{1}{2 π \sqrt{{L}_{R} {C}_{R}}} ∝ \frac{1}{size} & ( 2 )\end{matrix}$$

In equation (2), L_{R} is the equivalent inductance of the metamaterial cell, and C_{R} is the equivalent capacitance.

The equivalent inductance L_{R} is represented by equation (3):

$$\begin{matrix}Equation 3 & \\ {L}_{R} = \frac{{μ}_{0} {l}^{2}}{t} ∝ size & ( 3 )\end{matrix}$$

The equivalent capacitance C_{R} is composed of a gap capacitance C, and the load capacitance C_{C} of the lumped capacitive element, as represented by equations (4) and (5):

$$\begin{matrix}Equation 4 & \\ C = \frac{{ε}_{0} {ε}_{c} wt}{g} ∝ size & ( 4 )\end{matrix}$$

$$\begin{matrix}Equation 5 & \\ {C}_{R} = C + {C}_{C} & ( 5 )\end{matrix}$$

In this embodiment, a WR-3·4 waveguide (the internal dimensions are 432×864 square micrometers) is used as the waveguide 11 in order to achieve stable EM-mode propagation at 300 GHz. To obtain a metamaterial phase shifter in which the propagation aperture (window aperture) of this waveguide fully includes all the metamaterial cells and which has a uniform structure in the waveguide, it is desirable to design the phase shifter so that the multiple of the metamaterial cell period is equal to the waveguide height.

For example, when the size of the metamaterial cell is 216×216 square micrometers, 216×2=432 micrometers (the waveguide height) is satisfied. Similarly, 144×3=432 micrometers is satisfied when the cell size is 144×144 square micrometers, and 108×4=432 micrometers is satisfied when the cell size is 108×108 square micrometers.

The multiple of the metamaterial cell period need not completely match the waveguide height, and need only fall within a range in which the propagation aperture (window aperture) of the waveguide fully includes all the metamaterial cells, and an electromagnetic wave stably propagates in the EM mode.

Furthermore, a square is used as the shape of the metamaterial cell in this embodiment, but a rectangular periodic cell may also be used. It is also possible to use other shapes.

### Operation of Beamformer

The operation of the beamformer 10 according to this embodiment will be explained below.

### Characteristics of Metamaterial Cell

First, the calculation results of the characteristics of the metamaterial cell 121 to be used in the metamaterial phase shifter 12 of the beamformer 10 will be explained.

In the calculations, a square metamaterial cell is used as the metamaterial cell 121. The configuration of the metamaterial cell 121 is a so-called modified Jerusalem cross, and inclined 45 degrees compared to a typical Jerusalem cross.

An InP substrate is used as a substrate 122, the relative permittivity is 12.4, and thickness tₛ=50 micrimeters. These values are the values of a typical InP-based integrated circuit electronic chip.

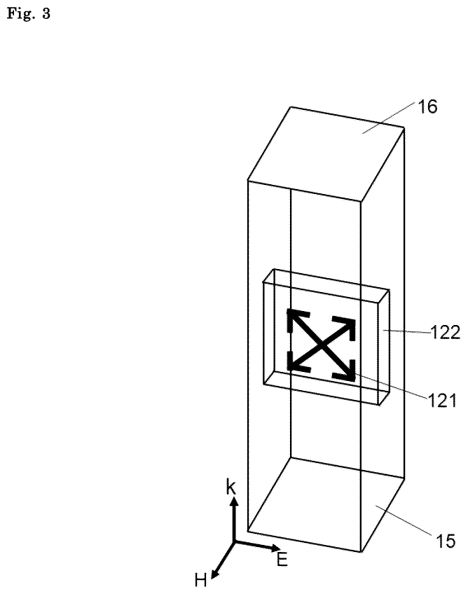

In the calculations of the characteristics of the metamaterial cell 121, the metamaterial cell 121 is placed as shown in FIG. 3. Referring to FIG. 3, a k direction is the transmission (propagation) direction of an electromagnetic wave, an E direction is the electric field direction, and an H direction is the magnetic field direction.

The metamaterial cell 121 is placed such that the longitudinal direction is an electromagnetic wave propagation direction from an input port (port 1) 15 to an output port (port 2) 16. In other words, the metamaterial cell 121 is placed so that the surface (on which the metamaterial cell is formed) is parallel to the k-E surface, and the longitudinal direction (the direction of one side of a square) of the metamaterial cell 121 is parallel to the electromagnetic wave propagation direction (k direction).

When the metamaterial phase shifter cell is placed in the longitudinal direction as described above, it is possible to reduce the transmission loss of an electromagnetic wave and give a high degree of freedom to the design of the metamaterial phase shifter, when compared to a case in which the metamaterial phase shifter is placed perpendicularly to the electromagnetic wave transmission direction.

Also, the cell is placed such that the direction of the gaps is parallel to the E direction of the electric field of an electromagnetic wave. The gap direction herein mentioned is a direction perpendicular to opposing end faces that form the gap. In addition, the modified Jerusalem cross type metamaterial cell 121 has gaps parallel to the E direction and the H direction, and the gap parallel to the E direction contributes to a resonance with the electromagnetic wave.

The calculations were executed on the electric field component of an electromagnetic wave along the x axis by using a time domain solution by setting periodic boundary conditions approximated to the vertical incidence direction.

Also, to achieve a high transmission coefficient that is S21<−3 dB in the 300-GHz frequency band, it was assumed that the period of the metamaterial cell 121 was constant, and the geometric parameters such as the gap size, cell size, and width of the metamaterial were optimized for an initial lumped capacitance of 0 fF.

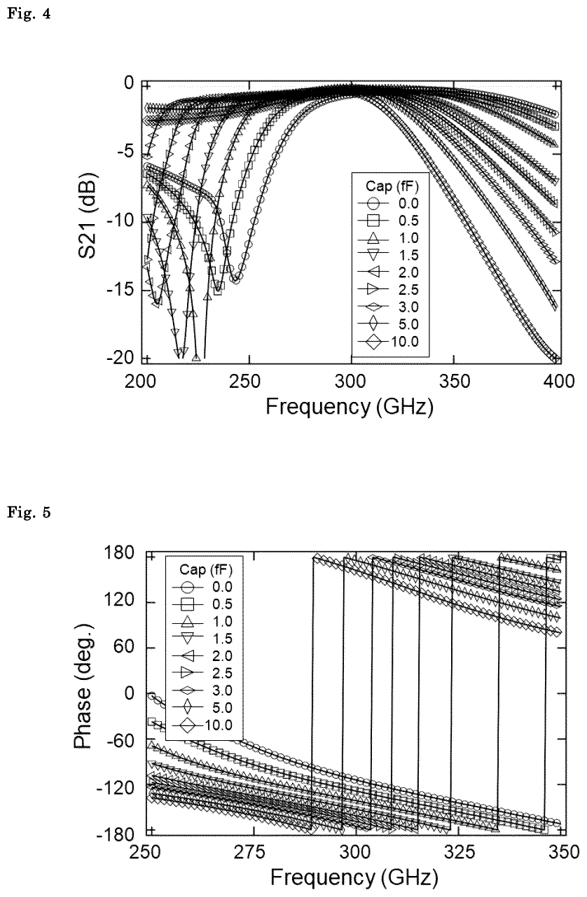

FIG. 4 shows the calculation results of the transmission coefficient spectra of the metamaterial cell 121 when the lumped capacitance is 0 to 10 fF.

When the lumped capacitance is increased from 0 to 10 fF, a frequency region (to be referred to as a “high-transmission region” hereinafter) showing a flat characteristic when the transmission coefficient S21 is −3 dB or more shifts to the low-frequency side. This shows high transmission of an electromagnetic wave at a frequency of 300 GHz.

When the capacitance value is low (0 to 3 fF), a phase variation is 10 degrees with respect to a capacitance change of 0.5 fF. When the capacitance value is high (5 to 10 fF), a phase variation is 2 degrees with respect to a capacitance change of 0.5 fF.

Since the initial value of the lumped capacitance of the metamaterial cell 121 is designed to be 0 fF as described above, the sensitivity of a phase variation with respect to a capacitance change of 0 to 3 fF is higher than the sensitivity with respect to a capacitance change of 5 to 10 fF.

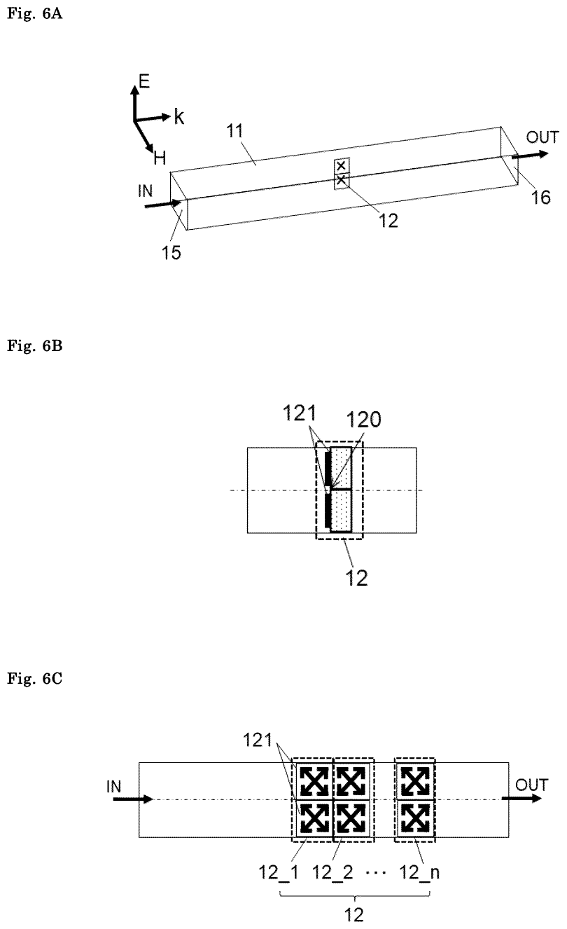

FIG. 5 shows the calculation results of the frequency dependence of the phase of the metamaterial 121 when the lumped capacitance is 0 to 10 fF.

For example, when the capacitance changes from 0 to 3 fF at 300 GHz, the phase varies from −120 degrees to −180 degrees. When the capacitance subsequently changes from 5 to 10 fF, the phase varies from 180 degrees to 150 degrees. Consequently, the phase varies 90 degrees in total.

### Characteristics of Waveguide

Next, the operation (characteristics) of the waveguide combined with the metamaterial phase shifter 12 will be explained.

In this arrangement, the metamaterial phase shifter chip 12 is formed by combining the metamaterial cells 121 so that they are included in the waveguide aperture in the k direction, and the chip is inserted into the metal waveguide 11 (WR 3·4).

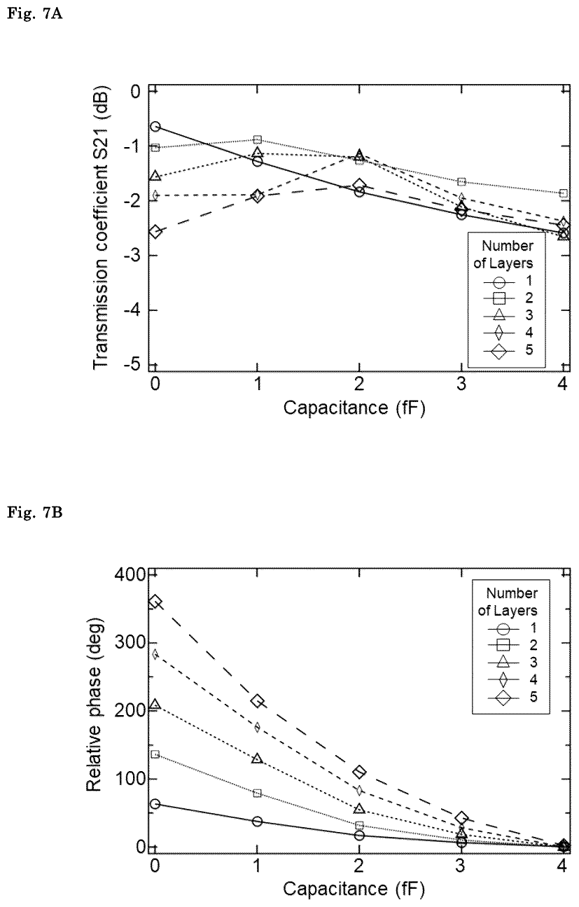

In the metal waveguide 11, as shown in FIG. 6A, a millimeter-wave signal is transmitted from the input (port 1) to the output (port 2) and passes through the metamaterial phase shifter chip 12. The direction of the electric field E is perpendicular to the transmission direction of the signal, and the direction of the lumped capacitive element (the direction of the gap) is parallel to the electric field E. As a result, the metamaterial phase shifter chip 12 (the metamaterial cell) combines with the electric field component of the input electromagnetic wave and resonates.

FIGS. 6B and 6C are respectively a front cross-sectional view and a side cross-sectional view of the metamaterial phase shifter chip in the waveguide 11.

In the metamaterial phase shifter chip 12, a plurality of metamaterial cells 121 are arrayed by 2×n. In this array, two metamaterial cells 121 combine with each other to form one layer. That is, the metamaterial phase shifter chip 12 includes n layers.

In the waveguide 11, the metamaterial phase shifter chip 12 is placed so that two metamaterial cells 121 are arrayed in the direction of the electric field E, and the first to nth layers are arrayed in the transmission direction (k direction).

Two metamaterial cells are arrayed in the direction of the electric field E in the above example, but the number is not limited to two and may also be one or three or more. As described previously, the device is desirably designed so that the multiple of the metamaterial cell period (the length of a single metamaterial cell in the direction of the electric field E) is equal to the waveguide height (the length of the waveguide in the direction of the electric field E).

As described above, the metamaterial phase shifter chip 12 is placed such that the surface is parallel to the E-k surface (the waveguide side surface), and the longitudinal direction (the direction in which a plurality of layered structures combine with each other) is parallel to the transmission direction (k direction).

The position of 0 as an initial value 120 is set not on the surface of the metamaterial cell but on the substrate surface, and exists on the vertical axis of symmetry of the waveguide 11. Since the metamaterial phase shifter chip 12 is placed in the longitudinal direction of the waveguide 11, the section is equal for different layers, and this makes the transmission characteristic constant.

The length of the metamaterial phase shifter 12 can freely be changed by changing the number of layers, so the total phase variation of a propagation signal can be increased.

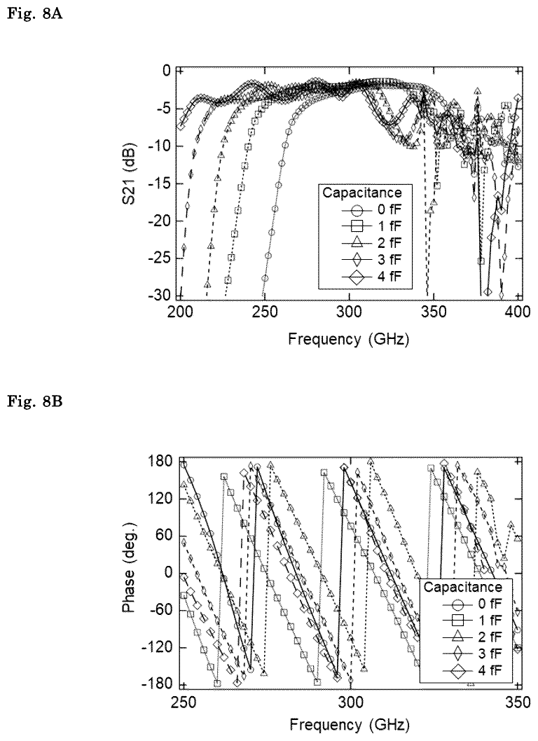

FIGS. 7A and 7B show the calculation results of the lumped capacitance value dependences of the transmission coefficient and the phase variation of a propagation millimeter wave with respect to the number of layers (one to five layers) of the metamaterial phase shifter. As shown in FIG. 7A, when the number of layers increases, high millimeter-wave transmission is observed with small fluctuation.

On the other hand, as shown in FIG. 7B, when the capacitance changes from 0 to 4 fF in phase shifters having one to five layers, the relative phase increases from about 60 degrees to about 360 degrees. Thus, the degree of freedom of the phase variation can be controlled by increasing the number of layers of the metamaterial phase shifter, with almost no influence on the transmission characteristic. Here, the relative phase is described later.

### Characteristics of Beamformer

The operation (characteristics) of the parallel waveguide beamformer 10 incorporating the metamaterial phase shifters 12 will be explained below.

The optimized five-layered metamaterial phase shifter chips 12 are mounted in parallel waveguides in order to form the waveguide beamformer 10.

The metamaterial cell 121 is made of a 200-nm thick thin metal film directly deposited on the InP substrate. The parameters of the metamaterial cell 121 are as follows: the size (length) l of the metamaterial cell 121 is 124 micrometers, the gap size g is 42 micrometers, the width w of the belt-like metal structure is 8 micrometers, and the cell period a is 216 micrometers. These parameters were adjusted so that a high transmission coefficient S21 of −3 dB was obtained at 300 GHz with respect to different lumped capacitance values.

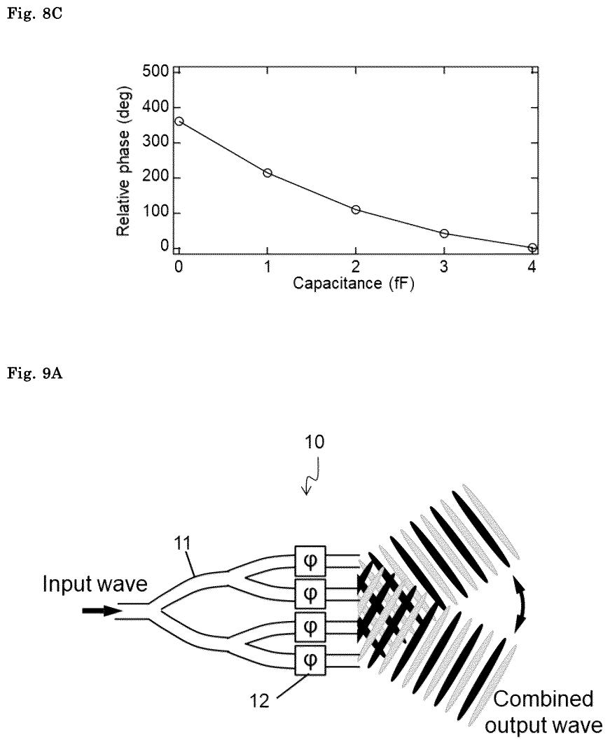

Here, the “relative phase” is obtained as follows. For example, from the frequency dependence of the phase shown in FIG. 8B, phase values at 300 GHz of −70, 130, −60, −150 and 160 degrees are obtained at capacitances of 0, 1, 2, 3 and 4 fF, respectively. These phase values are plotted by taking account of the phase varying with a period of 360 degrees. At the capacitance of 0 fF, by adding 360 degrees to the phase value of −70 degrees, 290 degrees are obtained. Also, at the capacitance of 4 fF, 360 degrees are subtracted from the phase value of 160 degrees, then-200 degrees are obtained. Subsequently, these values are plotted together with the phase values at the capacitances from 1 to 3 fF. Finally, each plot is shifted by 200 degrees so that the phase value at the capacitance of 4 fF of −200 degrees, which is the minimum value, becomes 0, then the relative phases are plotted as shown in FIG. 8C.

Next, the operation of the waveguide beamformer 10 will be explained.

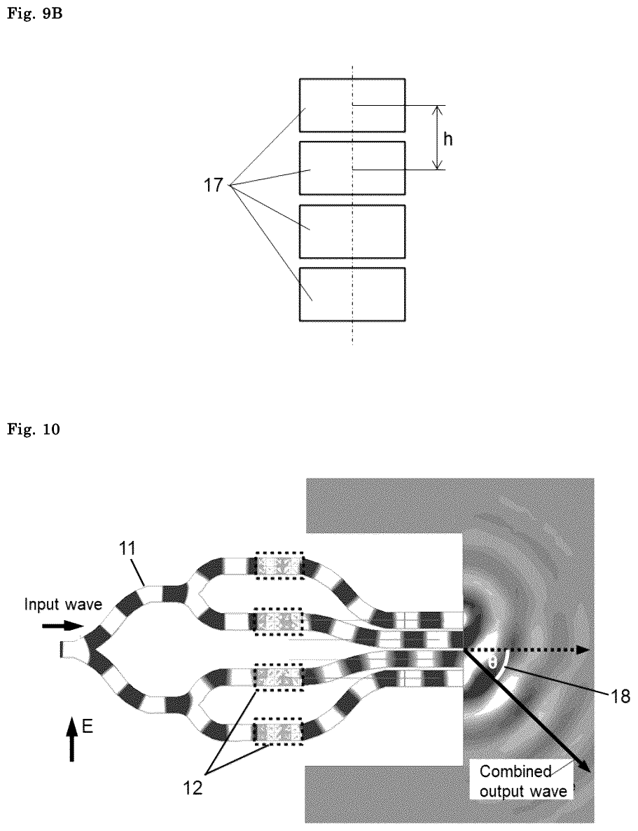

FIGS. 9A and 9B are schematic views showing the arrangement of the waveguide beamformer 10. In the waveguide beamformer 10, the waveguide 11 is branched twice and hence has four branched channels.

The limit (45 degrees) of the 300-GHz device can be increased by reducing the distance between the outputs of the waveguides. However, since the internal dimension of the WR-3·4 waveguide is 432 micrometers, it is difficult to fabricate a device having a metal structure of ultrathin layers. By contrast, reducing the size of the waveguide can reduce the distance between the waveguides (the distance between the centers of the waveguide apertures), and can increase the steering angle.

Furthermore, if it is difficult to form a metal structure of ultrathin layers in the WR-3·4 waveguide beamformer structure, the distance between the waveguide apertures can also be set at 0.6 to 0.7 mm.

$$\begin{matrix}Equation 6 & \\ {φ}_{x} = \frac{- 2 π h cos ( El ) sin ( Az )}{λ} & ( 6 )\end{matrix}$$

$$\begin{matrix}Equation 7 & \\ {φ}_{y} = \frac{- 2 π h sin ( Az )}{λ} & ( 7 )\end{matrix}$$

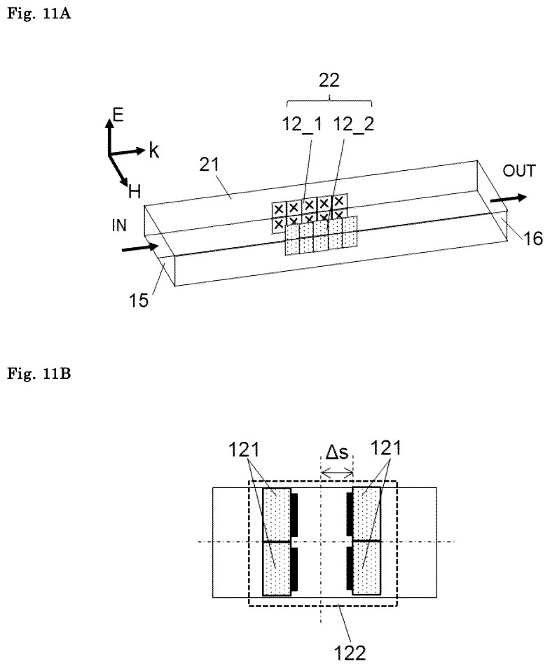

FIG. 10 shows signal propagation in the calculated waveguide beamformer 10.

Since the metamaterial phase shifter waveguide beamformer 10 can steer a beam at a wide angle as described above, it is possible to reduce the system loss, simplify the structure, and reduce the cost.

### Effects

The beamformer according to this embodiment uses the metamaterial in the phase shifter, and hence can increase the phase variation with a good transmission characteristic by using a simple structure, and implement wide-angle beam steering.

Also, the beamformer according to this embodiment does not require any complicated beamformer structure, and hence can reduce the load and cost of the fabrication process.

In conventional beamformers, millimeter-wave signals are amplified by an amplification integrated circuit mounted in a waveguide package, and propagated to a hollow metal waveguide by using a ridge coupler. The amplified signals are processed by a complicated phase shift network, combined, propagated to a radiation element (antenna), and radiated as a combined beam.

On the other hand, in the beamformer according to this embodiment, millimeter-wave signals are propagated in the waveguide, and the metamaterial phase shifters change the phases of the signals. Accordingly, this beamformer does not require any complicated phase shift network. In addition, the incident loss of the electrical phase shift circuit can be reduced, so signals are propagated in the waveguide with low losses.

Furthermore, in the beamformer according to this embodiment, the total directivity and the total gain are determined not by the physical dimensions of the radiation element but by signal amplification and the metamaterial phase shifter. It is also possible to reduce losses related to the connection of the antenna to the chip.

As described above, the structure of the metamaterial phase shifter is made compact and simplified. Also, the design and fabrication processes of the metamaterial phase shifter are summarized to the fabrication of the sub-wavelength metamaterial cell and the lumped capacitive element, and hence can be simplified. Accordingly, the conventional beamformer design and fabrication including a complicated waveguide package are largely simplified, and the total cost of the device is reduced.

The flexibility and simplicity in the design of the metamaterial phase shifter described above implement stable broadband transmission of radiated millimeter waves.

In this embodiment, the surface of the metamaterial phase shifter is parallel to the z direction (k direction). However, the present invention is not limited to this example. The angle between the surface of the metamaterial phase shifter and the z direction (k direction) can also be about ±1.5 degrees.

### Second Embodiment

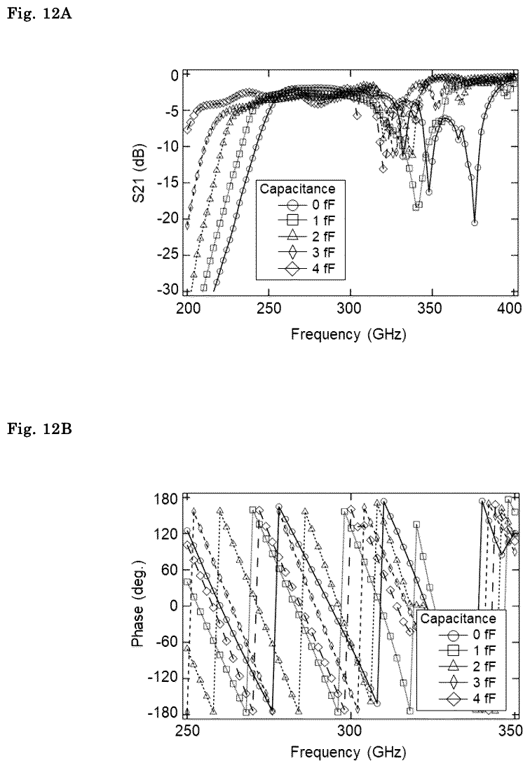

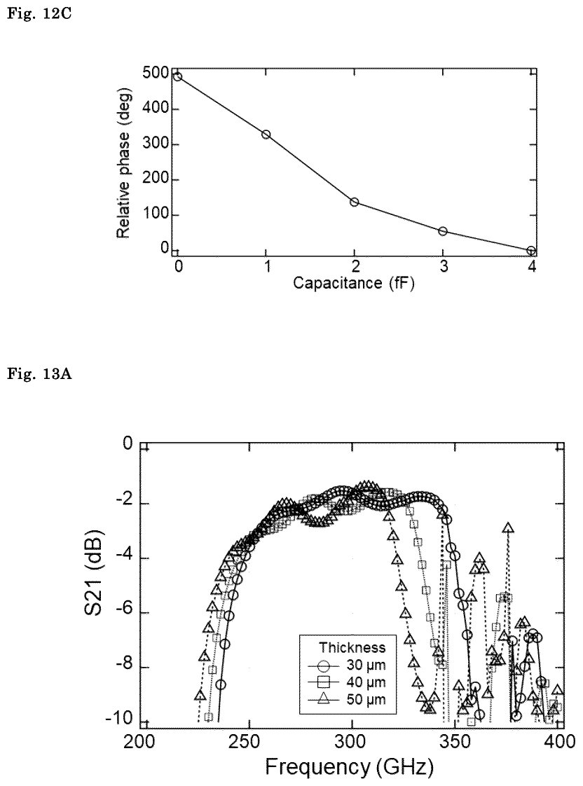

A beamformer according to the second embodiment of the present invention will be explained with reference to FIGS. 11A to 12C.

### Configuration of Beamformer

In this embodiment, two phase shifter chips 12 are mounted in each waveguide channel of a waveguide beamformer 20. The rest of the arrangement are substantially the same as that of the first embodiment.

As disclosed in the first embodiment, a phase variation of an electromagnetic wave propagating in a waveguide depends on the performance of a single metamaterial cell, and the phase of the electromagnetic wave varies in a high-transmission region.

In this embodiment, a phase variation range is increased by adding metamaterial cells, thereby making a high degree of freedom of device design and broadband beamforming of millimeter-wave signals possible.

In the beamformer 20 as shown in FIGS. 11A and 11B, a phase shifter 22 is formed by arranging two phase shifter chips 12_1, 12_2 in a waveguide 21 such that the surfaces (on which metamaterials are formed) of the two phase shifter chips 12_1, 12_2 oppose each other. The phase shifter 22 having this configuration will be referred to as a “mirrored phase shifter” hereinafter.

When the characteristics of the mirrored phase shifter 22 were calculated, as shown in FIG. 12A, the transmission coefficient decreases to about −3 dB at 300 GHz, and this is an allowable range in the operation of the phase shifter.

FIG. 12B shows frequency variations of the phase in lumped capacitive elements of 0 to 4 fF. FIG. 12C shows the capacitance dependence of a relative phase.

The relative phases are about 500 degrees, about 320 degrees, about 130 degrees, and about 50 degrees with respect to lumped capacitances of 0, 1, 2, and 3 fF, respectively, and these values are larger than that of the single phase shifter (the first embodiment, FIG. 8C).

The beamformer according to this embodiment can implement a phase variation of 360 degrees with a small capacitance and can operate in a wide frequency region, compared to the single phase shifter.

In addition, since the relative phase increases, the degree of freedom of the selection of a lumped capacitance variable range also increases, and this facilitates designing (the shape and size of) a metamaterial phase shifter cell. Furthermore, it is possible to reduce the transmission loss in a high-transmission region, and improve the operation characteristics of the beamforming system.

### Third Embodiment

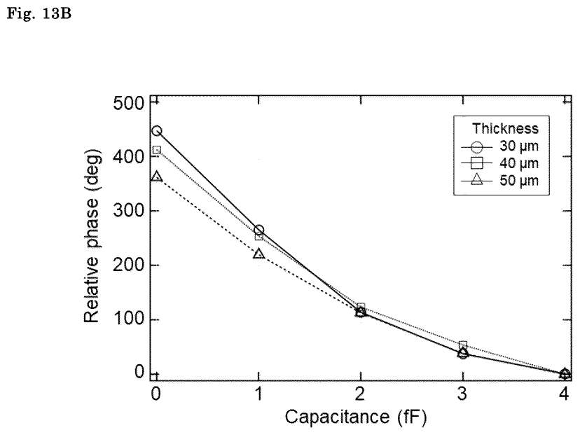

A beamformer according to the third embodiment of the present invention will be explained with reference to FIGS. 13A and 13B.

### Configuration of Beamformer

A beamformer 30 according to this embodiment uses a dielectric substrate having a reduced thickness. The rest of the configuration are substantially the same as those of the first and second embodiments.

However, the change in structure of the metamaterial phase shifter increases the relative volume of the dielectric substrate in the waveguide, and this produces additional losses.

In the beamformer 30, therefore, the thickness of the dielectric substrate is reduced.

FIG. 13A shows the transmission coefficient spectra of phase shifters in which the substrate thicknesses are different. Substrate thicknesses tₛ are 30, 40, and 50 micrometers. Five-layered metamaterial phase shifters were used, and the capacitance was fixed (C=2 fF).

Reducing the substrate thickness reduces losses in the dielectric film, so the transmission coefficient increases. The transmission coefficient particularly increases on the low-frequency side of the high-transmission region. This effect can compensate for losses produced in a long phase shifter or a mirrored phase shifter.

Also, as the substrate thickness decreases, the high-transmission region shifts to the high-frequency side. This is caused by the interference between the metamaterial cell and the substrate. As indicated by equation (4), the occurrence of resonance in the metamaterial cell depends on the effective permittivity of the gap material. Since the thickness of the substrate material exerts influence on the effective permittivity, the thickness of the substrate material has a relation to the shift of the high-transmission region. This effect is taken into consideration when designing the phase of the metamaterial phase shifter.

In addition, the width of the high-transmission region increases as the substrate thickness decreases. When the substrate thickness is 50 micrometers, the high-transmission region is 225 to 320 GHz. On the other hand, when the substrate thicknesses are 40 and 30 micrometers, the high-transmission regions are respectively 255 to 330 GHz and 255 to 345 GHz, that is, the width of the high-transmission region increases.

Furthermore, as shown in FIG. 13B, as the substrate thickness decreases, the relative phase increases within the capacitance range of 0 to 4 fF. When the substrate thickness is 50 micrometers, the relative phase is 360 degrees. On the other hand, when the substrate thicknesses are 40 and 30 micrometers, the relative phases are respectively 410 degrees and 450 degrees.

The beamformer according to this embodiment can improve the transmission characteristic and increase the phase variation. This makes it possible to increase the degree of freedom of the design and operation of the device, and improve the broadband operation characteristics of the waveguide beamformer.

### Fourth Embodiment

A beamformer according to the fourth embodiment of the present invention will be explained below.

### Configuration of Beamformer

In a beamformer 40 according to this embodiment, a plurality of arrayed amplification circuits are mounted. The rest of the configuration are substantially the same as those of the first to third embodiments.

In the first to third embodiments, a signal from an amplifier is branched into four waveguide channels, and the combined wave is formed into a beam that is steered in different directions. A large array includes a large number of output apertures, so the division (wave division) of a plurality of signals supplied from an amplifier produces a large output loss.

In the beamformer 40 according to this embodiment, therefore, instead of dividing a signal into parallel channels from a single amplification circuit, a plurality of arrayed amplification circuits are mounted and amplify an input wave.

In the beamformer 40, signals from the amplification circuits are simultaneously transmitted through waveguides, and metamaterial phase shifters shift the phases of these signals. Since all the amplification circuits operate by the same signal, the output signals from these amplification circuits have the same phase. Thus, phase shift is executed without any phase mismatch. Finally, the waveguide outputs are combined, and the combined wave is steered and radiated as a beam.

The beamformer according to this embodiment can execute phase shift without any phase mismatch, and increase the output of the radiated beam.

In the embodiments of the present invention, an example in which a plurality of metamaterial cells are combined has been explained. However, a single metamaterial cell may also be used.

In the embodiments of the present invention, an example using a monolayered metamaterial cell has been explained. However, a multilayered metamaterial cell may also be used.

In the embodiments of the present invention, examples of the structure, dimensions, material, and the like of each component have been explained in relation to the beamformer configuration, the manufacturing method, and the like. However, the present invention is not limited to these examples. It is only necessary to achieve the beamformer function and the effect.

### INDUSTRIAL APPLICABILITY

Embodiments of the present invention relate to a beamformer and is applicable to a millimeter-wave antenna and the like in high-frequency wireless communication.

### REFERENCE SIGNS LIST

10 . . . beamformer, 11 . . . waveguide, 12 . . . phase shifter, 13 . . . bias chip, 121 . . . metamaterial cell, 122 . . . dielectric substrate

1-8. (canceled)

9. A beamformer comprising:
a waveguide configured to transmit an electromagnetic wave;
a phase shifter in the waveguide; and
a bias chip electrically connected to the phase shifter,
wherein the phase shifter includes a metamaterial cell having a capacitive element, and
the bias chip is configured to change a capacitance of the capacitive element and a phase of the electromagnetic wave by applying a voltage to the metamaterial cell.

10. The beamformer according to claim 9, wherein:
the metamaterial cell includes conductive material and a gap in the conductive material, wherein the gap in the conductive material provides the capacitive element; and
a direction of the gap in the conductive material is parallel to an electric field component of the electromagnetic wave.

11. The beamformer according to claim 10, wherein the conductive material is gold, copper, aluminum, platinum, graphene, carbon nanotubes, or an electrically conductive oxide.

12. The beamformer according to claim 9, wherein the metamaterial cell is disposed in a transmission direction of the electromagnetic wave.

13. The beamformer according to claim 12, wherein the phase shifter further comprises a second metamaterial cell having a second capacitive element, wherein a surface of the metamaterial cell on which the capacitive element is disposed faces a surface of the second metamaterial cell on which the second capacitive element is disposed.

14. The beamformer according to claim 9, wherein:
the metamaterial cell is disposed in a perpendicular direction to a transmission direction of the electromagnetic wave; and
a multiple of a length of the metamaterial cell in the perpendicular direction is equal to an internal dimension of the waveguide in the perpendicular direction.

15. The beamformer according to claim 9, wherein the waveguide is a hollow metal waveguide.

16. The beamformer according to claim 9, wherein the waveguide is branched into a plurality of waveguides.

17. The beamformer according to claim 16, wherein each of the plurality of waveguides includes an amplification circuit.

18. A beamformer comprising:
a waveguide configured to transmit an electromagnetic wave;
a phase shifter in the waveguide; and
a bias chip electrically connected to the phase shifter,
wherein the phase shifter comprises a first metamaterial cell, the first metamaterial cell comprising a first conductive material on a first insulating material, the first conductive material being configured to generate a first capacitance, and
the bias chip is configured to change the first capacitance generated by the first metamaterial cell and a phase of the electromagnetic wave by applying a voltage to the first metamaterial cell.

19. The beamformer according to claim 18, wherein:
the first conductive material comprises a discontinuous portion, wherein the first capacitance is generated between surfaces of the first conductive material that are separated at the discontinuous portion; and
the surfaces of the first conductive material are separated in a parallel direction to an electric field component of the electromagnetic wave.

20. The beamformer according to claim 18, wherein the first conductive material is gold, copper, aluminum, platinum, graphene, carbon nanotubes, or an electrically conductive oxide.

21. The beamformer according to claim 18, wherein the first metamaterial cell is disposed in a transmission direction of the electromagnetic wave.

22. The beamformer according to claim 21, wherein the phase shifter further comprises a second metamaterial cell, the second metamaterial cell comprising a second conductive material on a second insulating material, the second conductive material being configured to generate a second capacitance, and wherein the first metamaterial cell and the second metamaterial cell are arranged such that the first conductive material and the second conductive material face each other.

23. The beamformer according to claim 18, wherein
the first metamaterial cell is disposed in a perpendicular direction to a transmission direction of the electromagnetic wave, and
a multiple of a length of the first metamaterial cell in the perpendicular direction is equal to an internal dimension of the waveguide in the perpendicular direction.

24. The beamformer according to claim 18, wherein the waveguide is a hollow metal waveguide.

25. The beamformer according to claim 18, wherein the waveguide is branched into a plurality of waveguides.

26. The beamformer according to claim 25, wherein each of the plurality of waveguides includes an amplification circuit.
